(19) United States
(12) Patent Application Publication
(10) Pub. No.: US 2012/0016994 A1
(43) Pub. Date: Jan. 19, 2012

(54) DISTRIBUTED SYSTEM

(75) Inventors: So Nakamura, Tokyo (JP); Ryo Fujino, Tokyo (JP); Fumio Shimura, Tokyo (JP); Hisashi Sato, Tokyo (JP); Tetsufumi Tsukamoto, Tokyo (JP)

(73) Assignee: HITACHI, LTD., Tokyo (JP)

(21) Appl. No.: 13/203,106

(22) PCT Filed: Feb. 23, 2010
(86) PCT No.: PCT/JP2010/001196

§ 371 Date: Oct. 7, 2011

(30) Foreign Application Priority Data
Mar. 3, 2009 (JP) 2009-048724

(51) Int. Cl. G06F 15/173

(52) U.S. Cl. 709/226

(57) ABSTRACT

In a distributed cluster environment in which multiple pieces of business processing are performed in one system, an individual load distribution method can be selected according to the prioritization in each business processing and the processing capability of a distributed node for executing the processing, the automatic adjustment of the threshold value of the load determined by a user is tried in load distribution, and even when the performances of bases of nodes which constitute the distributed cluster environment are not particularly uniform, it is possible to make the best use of resources in the distributed cluster environment by parallel execution.

### TECHNICAL FIELD

The present invention relates to load distribution in an information processing system, and more specifically to a technology for realizing load distribution of processing in a distributed cluster environment. The invention is applicable to an order system in an online format, an account management system in a batch format, etc. in a financial institution.

### BACKGROUND ART

Cluster technologies of operating a plurality of servers as a batch for the purpose of efficient system operation in an information processing system have been suggested conventionally. Of these technologies, the distributed cluster technology (environment) for distributing load thereof in particular has been suggested. However, due to a further increase in the amount of information processing in recent years, there have been demands for a technology of further distributing this load, and as a technology therefor, a technology disclosed in Patent Document 1 has been suggested. Patent Document 1 describes that in order to solve a problem caused by previously starting up a load-distribution server (RPC server) for all servers, load of one's own node is stored by using a load storage means, upon detection of excessive load, a destination node on which load can be increased is selected, and load transfer instructions are transferred to the destination node.

### PRIOR ART DOCUMENTS

### Patent Documents

Patent Document 1: Japanese Patent Application Laid-open No. 2000-137692

### SUMMARY OF THE INVENTION

### Problem to be Solved by the Invention

However, provided in Patent Document 1 for the load distribution in the distributed cluster environment where processing is performed by use of a plurality of nodes are generally just a load distribution method for general-purpose business processing and a load distribution method for distributed nodes having a uniform processing capability. Thus, no consideration is given to a load distribution method concerning about a distributed cluster environment composed of a plurality of pieces of business processing provided with priorities and distributed nodes having non-uniform processing capabilities.

For example, in a case of a securities business, assume that in daily online order trading processing, the amount of processing targeted on a specific brand suddenly increased and information waiting for processing accumulated in a queue. In this case, processing of the system-control system turned on thereafter at regular time and originally desired to be performed with a top priority may receive a lower priority. Thus, required upon determination of a load distribution method for the distributed cluster environment is study of a load distribution method such that the method is changed in accordance with a business in a flexible manner and a plurality of businesses are applied in the same system according to given rules.

### Means for Solving the Problem

The present invention selects for each processing a load distribution method which is in accordance with characteristics of each business processing and which indicates how load is distributed to nodes in a distributed cluster environment where a plurality of pieces of business processing are performed in the same system. The characteristics here include: priorities of the pieces of business processing; and a processing capability of the distributed node executing the processing. Moreover, the invention also includes making adjustment of load in accordance with a threshold value of previously defined (stored) load in the load distribution.

Here, the invention includes a mode below. A distribution system which connects together a plurality of nodes and a plurality of clients arranged in a distributed manner includes: storage means for storing a load distribution method in accordance with a characteristic of each business in each of the clients; means for detecting a resource utilization situation in each of the nodes; means for judging based on a result of the detection whether or not load distribution is required in any of the nodes; means for determining for which client's processing business processing in the node judged as a result of the judgment to require the load distribution is intended and specifying from the storage means the load distribution method in accordance with the characteristic of the determined business processing; and means for executing the load distribution in accordance with the specified load distribution method.

Moreover, in the distribution system according to the invention, the characteristic includes at least one of a priority of each business processing and a processing capability of each of the nodes. Further, the distribution system according to the invention further includes: a second storage means for storing the resource utilization situation in each of the nodes; and third storage means for storing a threshold value of the resource utilization situation in each of the nodes, wherein the means for determining makes determination through comparison between contents stored in the second storage means and in the third storage means.

Moreover, it is an object of the invention to provide a distributed cluster environment, a node load distribution method, and a node load distribution program that permit the best use of resources in the distributed cluster environment by parallelization even in a case where fundamental performance of modes forming the distributed cluster environment is not uniform.

### Effect of the Invention

The invention permits a technology of defining a condition of load distribution for each business to thereby permit node selection processing by which processing is appropriately distributed in accordance with the condition of the business performing the processing. Moreover, even in a case where nodes with different performances at different periods in a distributed cluster environment are introduced, uniform service can be provided without lowering a service level, thus realizing flexible enhancement of the distributed cluster environment.

### BRIEF DESCRIPTION OF THE DRAWINGS

FIG. 1 A diagram showing entire configuration of one embodiment of the present invention.

FIG. 2 A diagram showing one example of a node management table held by a client according to one embodiment of the invention.

FIG. 3 A diagram showing one example of a processing time management table held by the client according to one embodiment of the invention.

FIG. 4 A diagram showing one example of a mode setting table held by the client according to one embodiment of the invention.

FIG. 5 A diagram showing a flow chart when a load distribution mode in the client is an “adjustment mode” in a case where a distributed node has transmitted to the client notification of excess over a resource threshold value according to one embodiment of the invention.

FIG. 6 A diagram showing a flow chart in a case where the distributed node has transmitted to the client the notification of the excess over the resource threshold value and in a case where the distributed node has transmitted to the client notification of a decrease in a resource utilization ratio according to one embodiment of the invention.

FIG. 7 A diagram showing a flow chart in a case where the client has received from the distributed node the notification of the decrease in the resource utilization ratio according to one embodiment of the invention.

### EMBODIMENTS OF THE INVENTION

Hereinafter, an embodiment of the present invention will be described with reference to the drawings. The embodiment below is just illustrative, and the invention is not limited to this embodiment.

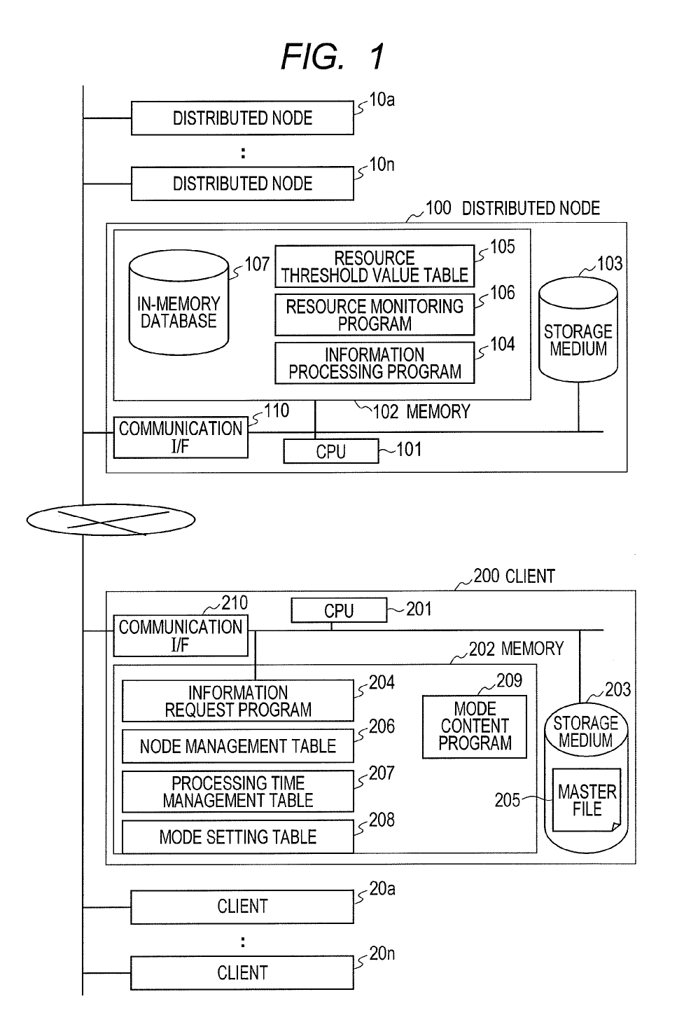

FIG. 1 shows a configuration diagram of an entire system according to this embodiment. The system according to this embodiment is composed of distributed nodes and clients, which are connected together in the same network in a manner such as to allow communication with each other. The client has, as a processing information obtaining means, a function as an input terminal and a gateway function of summarizing information transmitted from a different system and making a request of the distributed node for processing. The distributed node has, as processing information obtaining means, a gateway function of obtaining based on a transmission request transmitted from the client and obtaining by being given from a different distributed node the transmission request transmitted from the client. The gateway functions in the distributed node and the client may be in the same device or in different devices. Here, there are a plurality of distributed nodes and a plurality of clients, and they differ in process (program) during execution but have the same configuration. Therefore, the distributed nodes and the clients will be described, referring to a distributed node 100 and a client 200, respectively, as representative examples.

The distributed node 100 has: a CPU 101, a memory 102, a storage medium 103, and a communication interface 110, and lying on the memory 102 are: an information processing program 104 having logic for performing a plurality of pieces of business processing; a resource threshold value table 105 holding threshold value information of resources used in distribution processing; a resource monitoring program 106 monitoring a resource utilization ratio at fixed time intervals; and an in-memory database 107 for saving information processing results. The storage medium 103 may be realized by any medium, such as a hard disk or a memory, that realizes information saving. A target of the resource threshold value table 105 is not limited and thus can be, for example, the amount of information transmission and reception in the CPU, the memory, and the network as long as its contents can be regularly monitored, but the CPU will be described below as a representative example in the invention. Moreover, a value of the resource threshold value table 105 is set by a user upon node startup.

Next, the client 200 has: a CPU 201, a memory 202; a storage medium 203; and a communication interface 210, and lying on the memory 202 are: an information request program 204 making a request of an information processing program of the distributed node for information processing; a node management table 206 holding network information of all distributed nodes connectable from the client; a processing time management table 207 measuring and holding time required for the information processing in each distributed node; a mode setting table 208 defining a distribution processing method (called mode) for each business; and a mode content program 209 having contents of each distributed processing mode. Provided on the storage medium 203 is a master file 205 where information given to the information request program 204 is recorded, but the information given to the information request program 204 may be transmitted via the network through the communication interface 210. This storage medium 203, as is the case with the storage medium 103, may be realized by any medium that realizes information saving. Moreover, the client 200 may have configuration forming a hierarchical structure in the clients. For example, as a result of transmission from the client 20a present in the same network to the client 200 information specifying a range to be processed, the client 200 may operate in a form such that a function of relay to the distributed node is formed, for example, the information request program 204 operates based on this information.

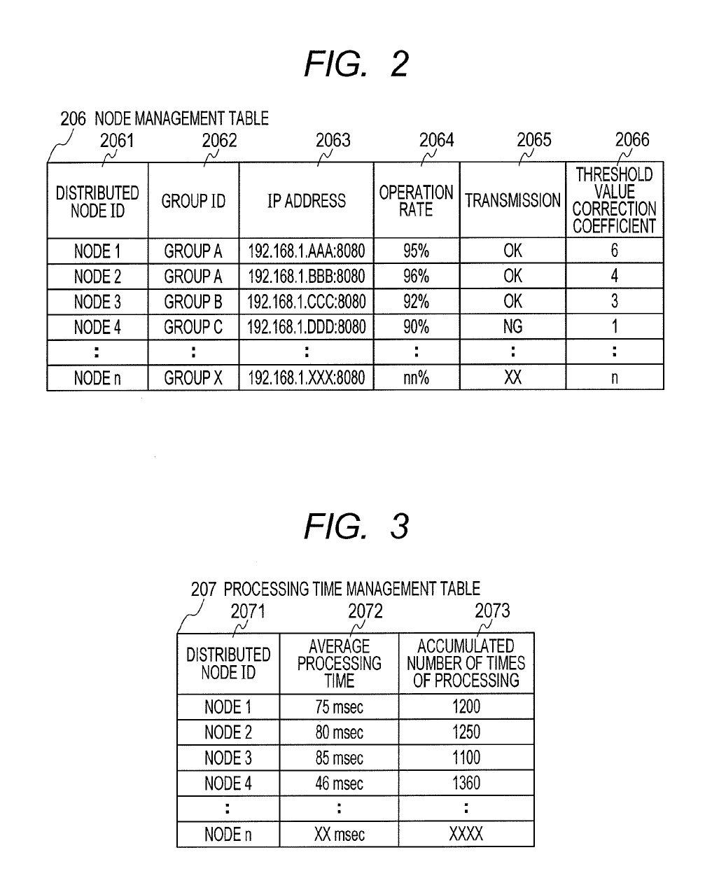

FIG. 2 shows one example of contents for the node management table 206. An entry of the node management table 206 is composed of: a distributed node ID 2061 which is held by each distributed node and which is unique in the same network: a group ID 2062 indicating grouping of the distributed nodes by the user; an IP address (including a port number) 2063; an operation rate 2064 indicating a ratio of time of being present in a processing candidate node list with respect to startup time; a flag 2065 expressing whether or not a state can be a target of transmission in the distribution processing method; and a threshold value correction coefficient 2066 used in a threshold value adjustment method to be described later. The distributed node transmits its own information to all the clients upon startup and ending, whereby the clients perform addition and deletion of the entries of the distributed nodes in the node management table. For determination of a destination of the distributed node in the information request program, the client uses the node management table 206.

FIG. 3 shows one example of contents of the time management table 207. Each client records each time from when a request for processing is provided to the distributed node to when notification of end of processing is received. The processing time management table 207 is composed of: a node ID 2071 that is unique to each distributed node; average processing time 2072 up to the present time; and 2073 that indicates the number of times of updating from startup to the present time.

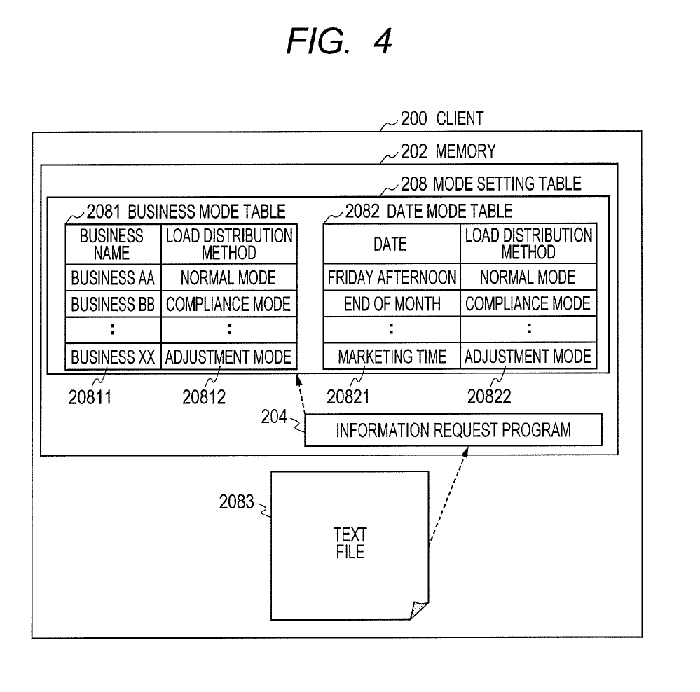

FIG. 4 shows one example of contents in two types of tables held by the mode setting table 208. A business mode table 2081 records in pairs business processing 20811 performed by the client and a load distribution mode 20812 to be described later. A time mode table 2082 records in pairs date and time 20821 on and at which the processing is executed and a load distribution mode 20822. As a result of providing, as an argument for time of starting up the client 200, a data mode table 2083 where contents of the business mode table 2081 and the date mode table 2082 are previously written, the information request program 204 of the client 200 interprets the data mode table 2083 at the time of startup, and reflects the contents onto the business mode table 2081 and the date mode table 2082. When the client 200 has received, from the distributed node 100, notification of excess over the resource utilization threshold value upon transmission from the client 200 to the distributed node information for processing, the client 200 uses the mode setting table 208 to specify a load distribution mode set for this business.

Subsequently, details of a case where each client selects, in the distribution processing, from the distributed nodes the distributed node to which a request for processing is given will be described, referring to the client 200 as an example. The client 200 selects, by using a round-robin method while referring to the node management table 206, the distributed node to which the request for processing is given, transmits, to the selected distributed node 100 (this example will be described referring to a case where the distributed node 100 is selected in the round-robin method), the information for the processing, and the distributed node 100 that has received it, in the information processing program 104 previously stored therein for the processing, specifies a business based on the transmitted information and executes the processing by using the corresponding logic. Here, for a unit of business processing for which the client makes a request of the distributed node, a design of division into smallest possible units, for example, one account in batch processing targeted on a plurality of accounts (for example, all accounts), is preferable for the purpose of providing maximum effect of calculation performance improvement achieved by parallelization realized by the distributed cluster environment. However, the embodiment of the invention does not limit the unit of the business processing. After the processing in the distributed node 100 ends, the distributed node 100 notifies the client 200 as a transmission source that the processing has ended normally, and the client 200 acquires next target information via the master file 205 or the communication interface 210. On the other hand, the distributed node 100 saves results of the information processing into the in-memory database 107. A destination into which they are saved is specified by the information processing program 104 in accordance with the business, and for example, results of information processing of a different business may be saved into not the in-memory database 107 but the storage medium 103.

Here, during the information processing performed by the distributed node 100, the resource monitoring program 106 executed in a different thread in the distributed node 100 is executed at fixed time intervals. If a resource utilization ratio exceeds a resource utilization ratio threshold value previously set in the resource threshold value table 105 by the user, the distributed node 100 transmits to each client notification of the excess over the threshold value and the threshold value recorded in the resource threshold value table 105. The client 200 has a mechanism of after receiving this notification (described here is a case where the client 200 has received it although all the clients receive it), referring to the mode setting table 208 and changing the behavior in accordance with the load distribution mode set for the current business.

There are three kinds of load distribution modes, which will be described individually below. The first mode is a “normal mode”, in which, even upon the reception, from the distributed node 100, the notification of the excess over the utilization ratio threshold value, the client 200 continues to determine in the round-robin method the distributed node of which the client 200 makes a request for processing. The distributed nodes subjected to close investigation in the round-robin method in the normal mode are the entries of the distributed nodes recorded in the node management table 206.

The second mode is a “compliance mode”, in which, upon the reception, from the distributed node 100, the notification of the excess over the threshold value, the client 200 consequently changes the transmission possible flag 2065 in the entry of this distributed node 100 in the node management table 206 from “OK” to “NG”. The distributed nodes subjected to close investigation in the round-robin method in the compliance mode are only the entries whose transmission possible flag 2065 is “OK”. As a result, for the distributed node whose transmission possible flag 2065 has turned to “NG”, the transmission of the information for processing from the client to which the compliance mode is applied may be prevented unless the transmission possible flag 2065 returns to “OK” again.

The third mode is an “adjustment mode”, in which, upon the reception, from the distributed node 100, the notification of the excess over the resource utilization ratio threshold value, the client 200 determines whether or not contents of the resource threshold value table 105 held in the distributed node 100 which has transmitted the notification of the excess over the resource threshold value brings about maximum efficiency in the current business. The details of this determination will be described at the next stage. The distributed nodes subjected to close investigation in the round robin method in the adjustment mode are, as is the case with the compliance mode, the entries whose transmission possible flag 2065 is “OK”.

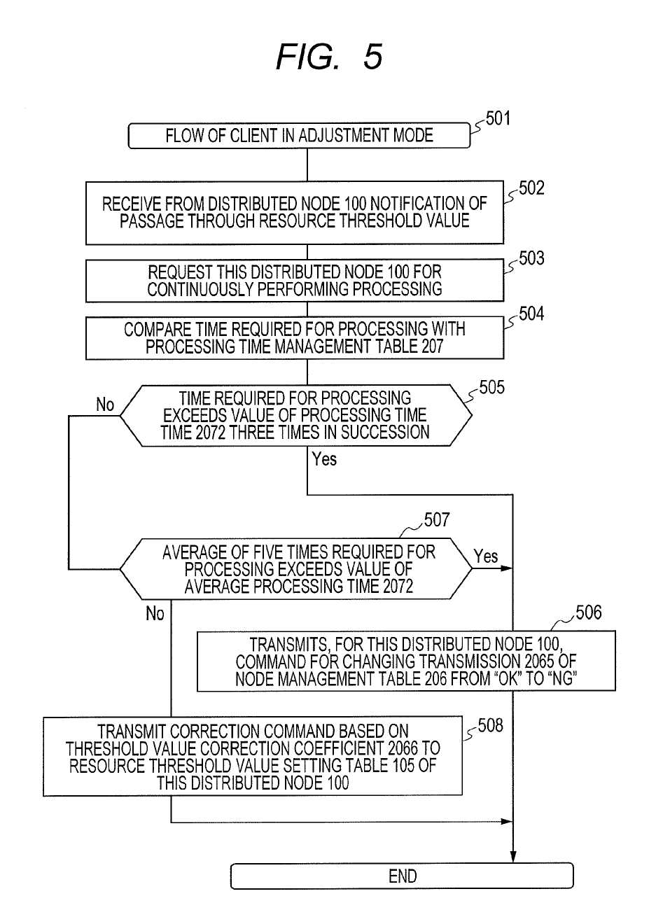

FIG. 5 shows the details of the determination in the adjustment mode. First, upon the reception, from the distributed node 100, the notification of the excess over the threshold value (step S502), the client 200 refers to the mode setting table 208 and recognizes that the current processing is in the adjustment mode. In the adjustment mode, to the distributed node 100 that has transmitted the notification of the excess over the resource threshold value, the client 200 transmits request information for making a request for continuously performing the processing (step S503). Time required for this processing is compared with the processing time management table 207 recording time required for the processing in a state before the reception of the notification of the excess over the resource threshold value (step S504). In this comparison, if the time exceeds the value of the processing time management table 207 three times in succession (step S505), the client 200 judges that the distributed node 100 cannot perform proper business processing for the excess over the resource threshold value, the client 200 changes the transmission possible flag 2065 of this distributed node 100 in the node management table 206 from “OK” to “NG” (step 506). Moreover, in step 505, also in a case where the time does not exceed the value of the processing time management table 207 three times in succession, if an average of time required for five times of processing exceeds the value of the processing time management table 207 (step 507), the processing transits to step S506. Note that the numbers of times (three times and five times) in steps 505 and 507 are just illustrative, and thus may be different times. These times are previously stored in the system.

If the average of the time required for the five times of processing does not exceed the value of the processing time management table 207 in step 507, the client 200 judges based on the time required for the processing that it is possible to perform proper business processing regardless of the excess over the current threshold value, and transmits a command for upwardly correcting a value in the contents of the resource threshold value table 105 of the distributed node 200 in accordance with the threshold value correction coefficient 2066 recorded in the node management table 206 (step 508). For example, where for the resource threshold value table 105, the CPU is a target of monitoring, the value is 70, and the threshold value correction coefficient 2066 is 3, 70×(1+0.03)=72.1, and thus the client 200 transmits a command for changing the contents of the resource threshold value table 105 from 70 to 72 obtained through rounding. In accordance with this command, the distributed node 100 updates the value of the resource threshold value table 105. By repeating this flow, the threshold value is pulled up in a stepwise fashion up to a value judged to obstruct the business processing (slow down the time required for the processing). However, if the corrected value exceeds 100, the command transmission is not performed (the command transmission is performed when the excess does not occur).

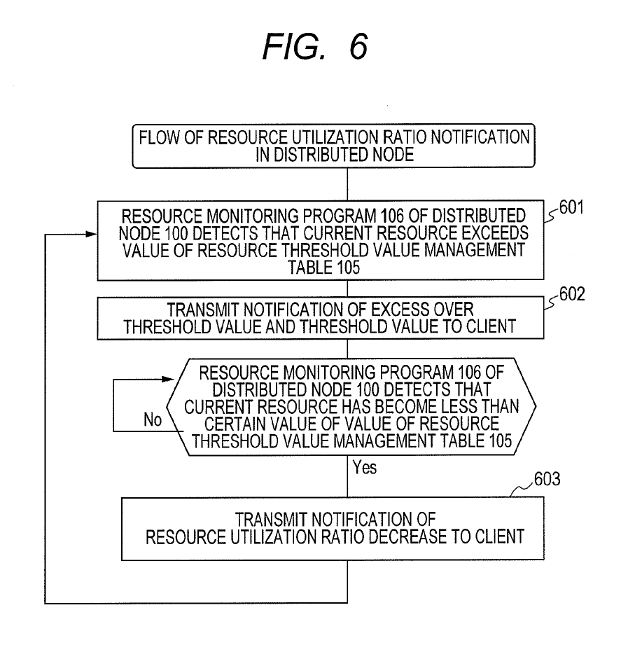

Next, procedures of notifying the excess over the resource threshold value by the distributed node 100 during the information processing will be described with reference to FIG. 6. If the resource utilization ratio of the distributed node 100 exceeds the value of the resource threshold value table 105 (step 601), the notification of the excess over the threshold value and the threshold value are transmitted to each client (step 602). If the resource utilization ratio has decreased to less than a fixed value of the value of the resource threshold value table 105 after step 602, notification of the decrease in the resource utilization ratio is given to each client (step 603). The fixed value here can be defined for each distributed node, and for example, step 603 may be applied upon a decrease to below 80% of the value of the resource threshold value table 105.

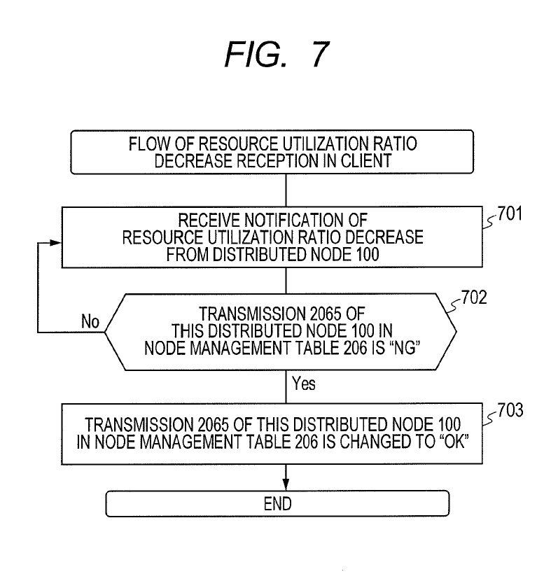

Subsequently, FIG. 7 shows an action made by the client 200 as a result of receiving from the distributed node 100 the notification of the decrease in the resource utilization ratio (all the clients receive the excess over the resource threshold value from the distributed node 100, but since all the clients have the same logic, a case of the client 200 will be described here). If the client 200 has received from the distributed node 100 the notification of the decrease in the resource utilization ratio (step 701), the client 200 checks its own node management table 206 to confirm whether or not the transmission possible flag 2065 of the entry of this distributed node 100 is “NG” (step 702). If the transmission possible flag 2065 of the distributed node 100 is “NG”, the client 200 judges that proper business processing can be performed again since in the node where the business processing is obstructed due to the excess of the resource utilization ratio, a margin has been provided again for the resource utilization ratio, and changes the transmission possible flag 2065 to “OK” (step 704). If this distributed node 100 is not present in the excluded node list 2062 in step 702, the processing is continuously executed until the situation of step 701 arises.

There is a possibility that as a result of notifying from each distributed node the excess over the resource, the transmission possible flags 2065 of all the entries in the node management table 206 in each client turn to “NG”. In this case, in the compliance and adjustment modes, the node list referred to in the round-robin method includes only those whose transmission possible flag 2065 is “OK”, and thus if the notification of the decrease to less than the fixed resource threshold value has been received, which has been described in step 603, from any distributed node whose transmission possible flag 2065 is “NG”, a request for new processing is provided to each distributed node (request information for requesting for processing is transmitted) (if the notification has not been received, the transmission of the request information may be suppressed). That is, if the notification of the decrease has not been received, the client turns into a state of standby for processing. Note that in the normal mode, the node to which a request for information processing is provided is selected from all the entries in the node management table 206, and thus the state of standby does not arise.

As described above, in the invention, by defining the load distribution mode for each business, it is possible to make a selection to use a given load distribution mode for each business through collaboration between the clients and the distributed nodes in the distributed cluster environment.

Also suggested for the load distribution mode is a mode not only simply complying with the specified threshold value but trying to adjust in a self-directive manner a threshold value set by the user within a range not causing service level decrease attributable to decrease in time required for business processing.

### DESCRIPTION OF REFERENCE NUMERALS

10a, 10n, 100 . . . Distributed node, 20a, 20n, 200 . . . Client.

1. A distribution system connecting together a plurality of nodes and a plurality of clients arranged in a distributed manner, the distribution system comprising:
storage means for storing a load distribution method in accordance with a characteristic of each business in each of the clients;
means for detecting a resource utilization situation in each of the nodes;
means for judging based on a result of the detection whether or not load distribution is required in any of the nodes;
means for determining for which client's processing business processing in the node judged as a result of the judgment to require the load distribution is intended and specifying from the storage means the load distribution method in accordance with the characteristic of the determined business processing; and
means for executing the load distribution in accordance with the specified load distribution method.

2. The distribution system according to claim 1,
wherein the characteristic includes at least one of a priority of each business processing and a processing capability of each of the nodes.

3. The distribution system according to claim 1, further comprising:
second storage means for storing the resource utilization situation in each of the nodes; and
third storage means for storing a threshold value of the resource utilization situation in each of the nodes,
wherein the means for determining makes the determination through comparison between contents stored in the second storage means and in the third storage means.

4. The distribution system according to claim 1,
wherein the clients form a hierarchical structure therein, are divided in the same network into clients specifying a range of an information processing request and clients making the information processing request, and perform information processing on the distributed nodes.

5. The distribution system according to claim 3,
wherein the second storage means has a resource utilization ratio management table storing a resource utilization ratio indicating the resource utilization situation,
the third storage means has a resource threshold value table indicating a threshold value of the resource utilization situation, and
the means for determining monitors the resource utilization management table at predetermined intervals, and upon excess over the value of the resource threshold value table as a result of the monitoring and upon a decrease to less than a fixed value of the value of the resource threshold value table, notifies each of the clients of the excess or the decrease.

6. The distribution system according to claim 1, further comprising:
fourth storage means holding a node information table storing node information related to each of the nodes and including a flag indicating whether or not a further processing request can be transmitted; and
means for using the flag in the specified load distribution method and executing a selection of the distributed node targeted for the transmission of the processing request.

7. The distribution system according to claim 6,
wherein one of the load distribution methods stored in the storage means includes the load distribution method of reading in order entries of a list of the nodes to which the processing request is transmitted and selecting a transmission destination.

8. The distribution system according to claim 6,
wherein one of the load distribution methods stored in the storage means includes the load distribution method of, upon receiving, from the node, notification of excess over the resource threshold value, permitting a change of an entry of the node, from which the reception is performed, to an excluded node excluded from processing, whereby the node is excluded from the transmission destination of the processing request.

9. The distribution system according to claim 6,
wherein one of the load distribution methods stored in the storage means include the load distribution method of ⁽¹²⁾transmitting a command for, upon receiving, from each of the nodes, notification of excess over the resource threshold value, measuring processing time in the distributed node, and when no performance deterioration due to response time is found, upwardly correcting a value of the resource utilization ratio management table of the distributed node.
